(19) United States
(12) Patent Application Publication
(10) Pub. No.: US 2021/0008759 A1
(43) Pub. Date: Jan. 14, 2021

(54) FORMWORK ASSEMBLY

(71) Applicant: Progress Holding A.G., Brixen (IT)

(72) Inventors: Helmut STOFNER, Sarntal (IT); Alexander STUFLESSER, Lajen (IT)

(21) Appl. No.: 17/003,343

(22) Filed: Aug. 26, 2020

Related U.S. Application Data
(63) Continuation of application No. PCT/EP2019/054746, filed on Feb. 26, 2019.

(30) Foreign Application Priority Data
Mar. 6, 2018 (AT) A 50184/2018

(51) Int. Cl. B28B 7/00; B28B 17/00; B28B 7/02

(52) U.S. Cl. CPC B28B 7/0017; B28B 7/02; B28B 7/002; B28B 17/0081

(57) ABSTRACT

A formwork assembly includes a base body to be fastened detachably to the formwork surface, and an attachment element. A fastening device can release the at least one attachment element, in particular automatically, from the at least one base body. At least one centering device is provided separate from the at least one fastening device, by which the attachment element when fixed to the base body can be automatically aligned relative to the base body. The base body and the attachment element can be arranged, in the fixed state, together on the formwork surface and can be removed from the formwork surface.

### BACKGROUND OF THE INVENTION

The invention concerns a formwork assembly for laterally delimiting a surface to be concreted on a formwork surface, in particular a pallet or a formwork table, comprising at least one base body which can be releasably fixed to the formwork surface and at least one attachment element, wherein there is provided at least one fixing device with which the at least one attachment element can be fixed releasably and in particular automatically to the at least one base body. The invention further concerns a storage apparatus for such a formwork assembly, an assembly comprising at least one such formwork assembly and at least one formwork robot, and a method of producing a formwork on a formwork surface, in particular a pallet or a formwork table, by means of such a formwork assembly.

Formwork assemblies are used in concrete plants in which precast concrete parts are being produced in pallet circulation installations for positioning the liquid and later hardened concrete. Formwork assemblies however are also employed in stationary systems in which for example tilt tables are used.

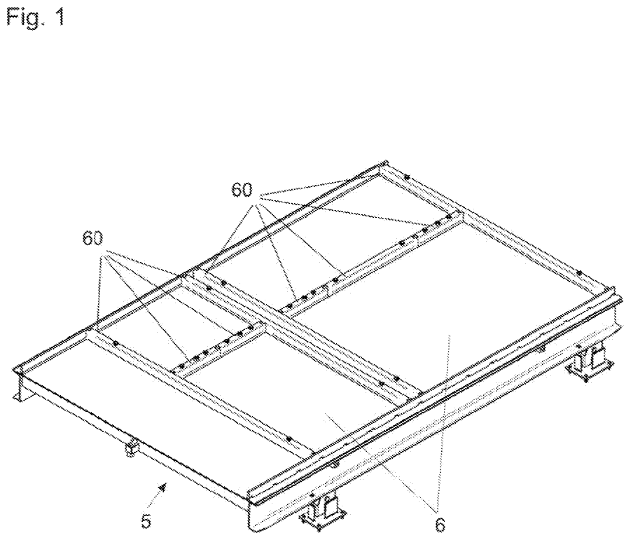

FIG. 1 shows a pallet 5 with formwork elements 60 which are arranged thereon and which laterally delimit surfaces 6 to be concreted on the pallet 5. The filling amount of concrete is defined by the height of the precast concrete part to be produced and the area less other installed components like for example nozzles or iron lattice members. The thickness of the precast concrete part is defined by the formwork height. High formworks are used for solid concrete elements. The geometry of the side surfaces of such solid concrete elements varies very greatly. The formwork elements have to be of correspondingly different configurations. It is to be noted in this context that the present invention however is not limited to formwork assemblies for the production of solid concrete elements.

Short ordering and delivery times are involved in the variety of precast concrete parts to be manufactured, and they overall require a high level of flexibility in production.

Formwork assemblies are known from the state of the art, which include formwork parts for any element thickness and contour. A disadvantage of that system is that a very large amount of formwork parts is required. In addition such a system is very costly as each formwork element has to be equipped with a device for releasably fixing the formwork element to the pallet. In addition all formwork parts have to be produced in such a way as to be stable in shape and very precise.

In addition there are solutions in which steel profile members of the desired height and length for the formwork part are manually screwed on to a formwork which is already placed on the pallet. The disadvantage of those solutions is that accessibility to the formworks which are already positioned on the pallet is difficult as the pallets are up to 4 metres in width and it is necessary to avoid treading on the pallet because of the necessary cleanliness for the pallet surface.

In addition, formwork systems are known from the state of the art, in which an attachment or falsework profile member is automatically fitted on a formwork. A disadvantage of those systems is that the attachment components for the formwork have to be stable in shape and make it difficult to gain access to the device for releasably fixing the formwork to the pallet. Further disadvantages are that in the case of attachment systems an imprint of the attachment parts on the concrete surface is always apparent and that, in order to produce a concrete part of a modified contour, both the basic formwork and also the attachment parts have to be replaced.

And finally, formwork systems are known from the state of the art, in which special steel adaptors are fixed on a formwork which is already placed on the pallet. Wooden panels are then manually screwed to the adaptors. A disadvantage of those systems is once again that accessibility to the formworks already positioned on the pallet is difficult as the pallets are up to 4 metres in width and treading on the pallet has to be avoided by virtue of the necessary cleanliness for the pallet surface, In addition the wooden panels have to be prepared in a joinery workshop and taken to the location for manual fitment to the adaptor.

### SUMMARY OF THE INVENTION

The object of the present invention is to provide a formwork assembly which is improved over the state of the art and in which the above-mentioned disadvantages are at least partially avoided and which in particular is distinguished in that it can be fully automatically assembled and flexibly matched to the precast concrete part to be produced. In addition, the invention seeks to provide a storage apparatus for such an improved formwork assembly, an assembly comprising at least one such improved formwork assembly and at least one formwork robot, as well as a method for producing a formwork on a formwork surface, in particular a pallet or a formwork table, by means of such an improved formwork assembly.

In the formwork assembly according to the invention, at least one centring device is separate from the at least one fixing device and with which the at least one attachment element upon fixing of the at least one attachment element to the at least one base body can be automatically aligned relative to the at least one base body. The at least one base body and the at least one attachment element can be arranged in the fixed state together on the formwork surface and can be removed from the formwork surface.

By virtue of the division into at least one base body which can be releasably fixed to the formwork surface and at least one attachment element which can be releasably fixed to the at least one base body, the formwork assembly on the one hand is highly flexible as it is always possible to use the same universal base body. Depending on the precast concrete part to be produced it is combined with the appropriate attachment element or elements.

By virtue of the fact that at the same time there is at least one centering device with which the at least one attachment element upon fixing of the at least one attachment element to the at least one base body can be aligned relative to the at least one base body, it is possible for the at least one base body and the at least one attachment element to be easily assembled as in that case mutual alignment takes place automatically. This measure represents an essential prerequisite for fully automatic assembly although the present invention is not limited to fully automatic situations of use. Even in the situation involving manual assembly of the at least one base body with the at least one attachment element, automatic mutual alignment relative to each other is found to be extremely helpful as operating errors which can lead to inaccuracies are excluded.

The at least one base body is admittedly technically more complex in comparison with some solutions in the state of the art as in fact the at least one centering device and some components of the at least one fixing device additionally have to be provided. It will be noted, however, that the wide variety of possible uses affords a much higher level of utilization and universal applicability. The attachment formworks can also be produced at the same time easily and inexpensively.

A further great advantage is that the at least one base body and the at least one attachment element can first be fitted together, more specifically at a location separate from the formwork surface, and the set consisting of the at least one base body and the at least one attachment element can then be arranged on the formwork surface and removed from the formwork surface. In comparison therewith, a scenario in which the at least one base body and the at least one attachment surface have to be assembled on the formwork surface itself is on the one hand more complicated and more time-consuming as the at least one base body and the at least one attachment element have to be positioned successively on the formwork surface. On the other hand in that case, there is a danger that the at least one attachment element may slip upon being assembled, leading to inaccuracies.

An advantageous embodiment of the invention provides that the at least one centering device includes at least one centering pin arranged preferably on the at least one attachment element and at least one opening arranged preferably on the at least one base body for receiving the at least one centering pin. That provides a centering device which is technically simple to implement and at the same time particularly reliable.

It can further be provided that the at least one attachment element has a side facing towards the surface to be concreted, and an opposite side facing towards the at least one base body. Preferably, the side facing towards the surface to be concreted has at least one contour portion differing from a plane for producing a predetermined contour at a side surface of a precast concrete part to be produced.

In addition, the at least one attachment element on the side towards the at least one base body has at least one concrete screening device in order in a state in which the at least one attachment element is releasably fixed to the at least one base body to prevent penetration of concrete into an intermediate space between the at least one attachment element and the at least one base body.

A further measure for preventing concrete from penetrating into the intermediate space between the at least one attachment element and the at least one base body provides that the at least one base body in a state in which the at least one base body is fixed to the formwork surface has an underside towards the formwork surface and in a state in which the at least one attachment element is releasably fixed to the at least one base body it has a side surface facing towards the at least one attachment element. In the region in which the underside meets the side surface, the base body has at least one recess so that in the state in which the at least one base body is fixed to the formwork surface, the at least one base body has in that region a spacing relative to the formwork surface. Without the provision of that recess, there is a danger that the concrete is ‘sucked’ by capillary forces into the intermediate space between the at least one attachment element and the at least one base body.

In particular, in regard to storage of the at least one attachment element, it has been found to be particularly desirable if the at least one attachment element has a substantially plate-shaped configuration. In that way, the space required for the at least one attachment element in a storage apparatus is substantially less than formwork parts which are known from the state of the art and which are produced completely for each contour. The term ‘substantially plate-shaped’ signifies that the at least one attachment element has a plate-shaped configuration apart from any contour portions, constituent parts of the at least one centring device and/or optionally provided concrete screening devices. The plate-shape is also advantageous in regard to cleaning the at least one attachment element.

It has further proven to be advantageous if the at least one fixing device includes at least one permanent magnet preferably arranged on the at least one base body and at least one magnetizable region arranged on the at least one attachment element. That provides not just a reliable solution in terms of releasably fixing the at least one attachment element to the at least one base body. More specifically, the force of the at least one permanent magnet does not work only in the fixing state, but is already operative in the assembly procedure so that the at least one base body and the at least one attachment element upon being fitted together are not only automatically aligned relative to each other—by the at least one centring device provided according to the invention—but are also automatically moved towards each other and releasably fixed.

Further advantageous configurations of the formwork assembly provide that the at least one base body has at least one formwork surface fixing device for releasably fixing the base body to the formwork surface and/or at least one engagement means for a formwork robot. Those measures are advantageous precisely in combination with the use of at least one attachment element—instead of fitment profile members as in some systems according to the state of the art, as accessibility to the at least one formwork surface fixing device and handleability of the at least one base body is in no way adversely affected by the presence of the at least one attachment element. Thus, it is possible to move the at least one base body by the formwork robot and/or to fix it releasably to the formwork surface even when at least one attachment element is already releasably fixed to the at least one base body.

As stated in the opening part of this specification, protection is also claimed for a storage apparatus for a formwork assembly according to the invention. The storage apparatus has at least one release device for releasing the fixing between the at least one base body and the at least one attachment element, and preferably the at least one release device includes two spreading elements displaceable relative to each other. In that way, it is possible for the formwork assembly according to the invention to be very efficiently retrofitted and for the components of the formwork assembly which are not required to be stored in the interim for use at a later time.

An advantageous development of the storage apparatus provides that the storage apparatus includes at least one gripping device for transporting the at least one base body and/or the at least one attachment element.

In that respect, the at least one gripping device is in the form of a magnetic gripper and/or has at least one head pivotable about an axis which in the position of use is substantially horizontal and/or is adapted to be displaceable in three mutually perpendicular directions in space, and preferably linear guides are provided to provide the displaceability.

Further advantageous configurations of the storage apparatus provide that the storage apparatus includes at least one transport device for transporting the at least one base body and/or the at least one attachment element from and to at least one formwork robot and/or an operator. Preferably, the at least one transport device includes a roller track, and/or at least one storage facility for the at least one base body and/or the at least one attachment element, and preferably the at least one storage facility is adapted to be displaceable, particularly preferably wherein the at least one storage facility is in the form of a displaceable tray.

Protection is also claimed for an assembly comprising at least one formwork assembly according to the invention and at least one formwork robot with which the at least one base body together with the at least one attachment element can be automatically arranged on the formwork surface at a predetermined position, preferably predetermined by CAD data and the at least one base body can be automatically releasably fixed to the formwork surface, preferably wherein the assembly includes at least one storage apparatus according to the invention.

In a preferred embodiment, the fixing of the at least one base body at the formwork surface can be automatically released by the at least one formwork robot, and the at least one base body can be automatically removed from the formwork surface together with the at least one attachment element.

And finally, protection is claimed for a method of producing a formwork on a formwork surface, in particular a pallet or a formwork table, by a formwork assembly according to the invention, wherein the method includes the following steps:

i. providing at least one base body and at least one attachment element,

ii. automatically aligning the at least one attachment element by the at least one centering device relative to the at least one base body,

iii. fixing releasably and preferably automatically the at least one attachment element to the at least one base body by the at least one fixing device,

iv. preferably automatically arranging the at least one base body together with the at least one attachment element by at least one formwork robot on the formwork surface at a predetermined position, preferably predetermined by CAD data, and

v. releasably fixing the at least one base body to the formwork surface, preferably automatically, by at least one formwork robot.

Advantageously steps i. to v. are repeated with further base bodies and attachment elements until a predetermined surface to be concreted is completely laterally delimited, preferably wherein the surface is then concreted.

For dismantling the formwork:

vi. the fixing of the at least one base body to the formwork surface is preferably automatically released by at least one formwork robot,

vii. the at least one base body together with the at least one attachment element is preferably automatically removed from the formwork surface by means of at least one formwork robot, and

viii. preferably the at least one base body and the at least one attachment element are then released from each other, cleaned and/or positioned in at least one storage facility.

Storage or cleaning of the at least one base body and the at least one attachment element is effected separately or in the assembled state.

### BRIEF DESCRIPTION OF THE INVENTION

Further details and advantages of the invention are described more fully hereinafter by means of the specific description with reference to the drawings in which:

FIG. 1 is a perspective view of a pallet with formwork elements arranged thereon according to the state of the art,

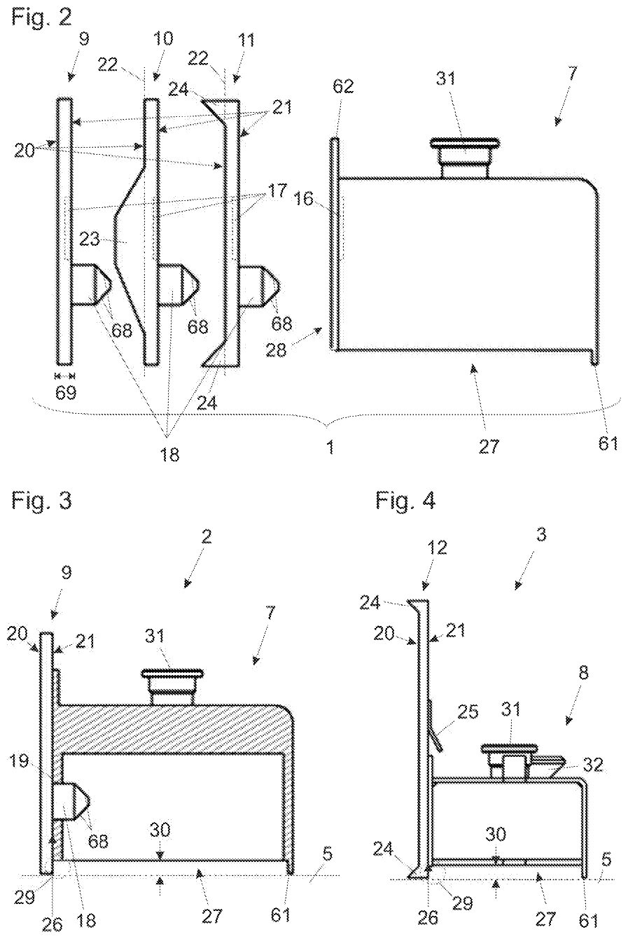

FIG. 2 is a diagrammatic view from the side of a first preferred embodiment of a non-assembled formwork assembly,

FIG. 3 is a diagrammatic cross-sectional view of a second preferred embodiment of an assembled formwork assembly,

FIG. 4 is a diagrammatic view from the side of a third preferred embodiment of an assembled formwork assembly,

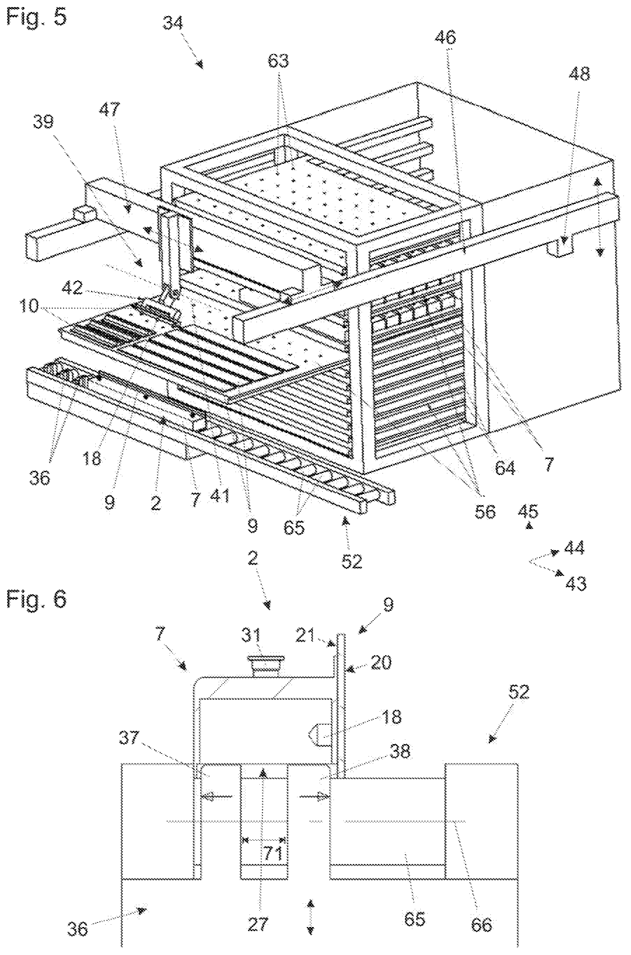

FIG. 5 is a diagrammatic perspective view of a first preferred embodiment of a storage apparatus,

FIG. 6 shows a transport device with a formwork assembly according to the second preferred embodiment and a release device as a diagrammatic cross-sectional view,

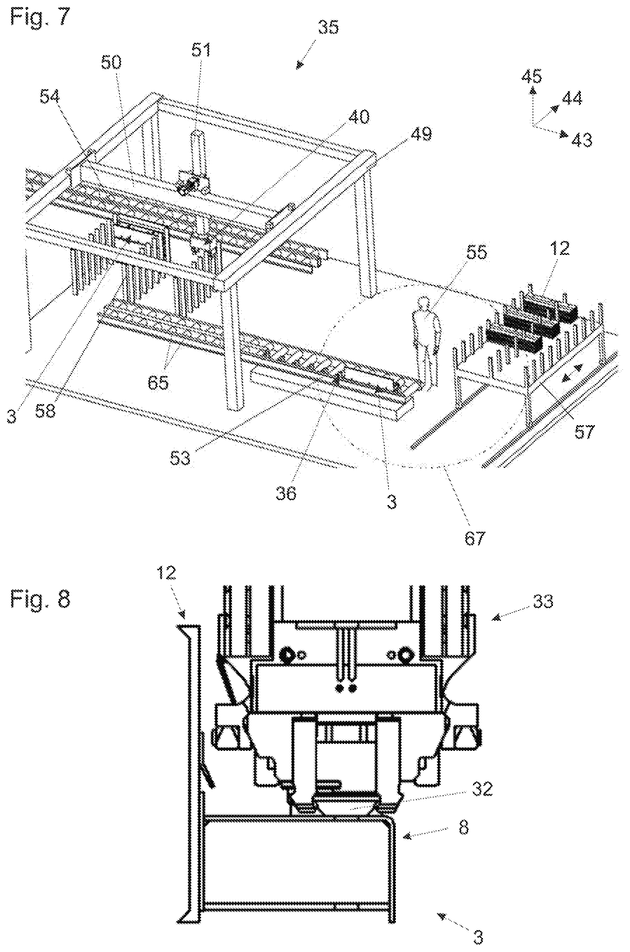

FIG. 7 is a perspective view of a diagrammatically illustrated second preferred embodiment of a storage apparatus,

FIG. 8 is a diagrammatic view from the side of a part of a formwork robot with a formwork assembly according to the third preferred embodiment,

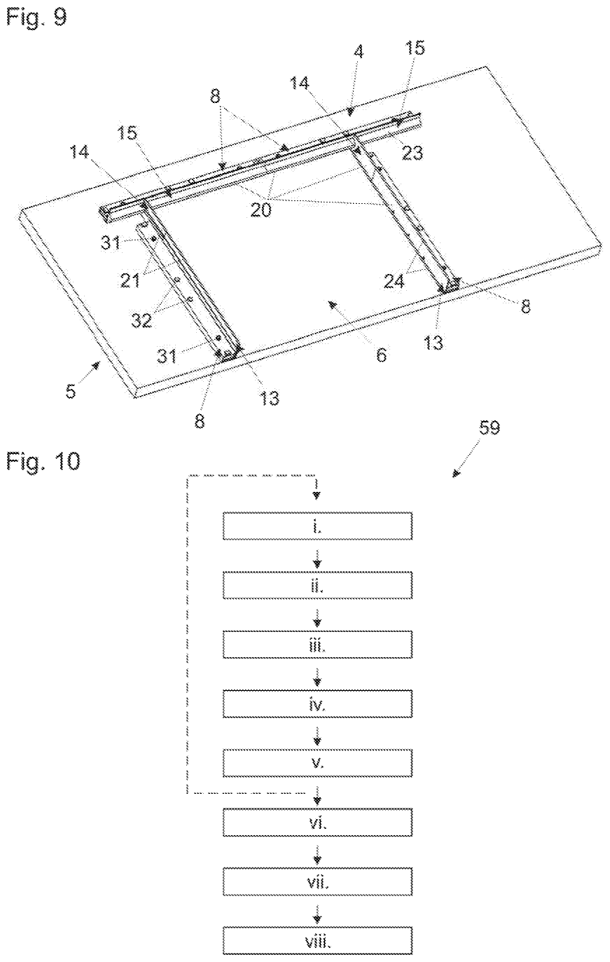

FIG. 9 is a perspective view of a diagrammatically illustrated fourth preferred embodiment of an assembled formwork assembly, and

FIG. 10 is a flow chart to illustrate a preferred embodiment of the method according to the invention.

### DETAILED DESCRIPTION OF THE INVENTION

FIG. 1 has already been described in the preamble to the description.

FIG. 2 shows a first preferred embodiment of a non-assembled formwork assembly 1 for laterally delimiting a surface to be concreted on a pallet, with a base body 7 which can be releasably fixed to the pallet and an attachment or falsework element 9, 10 and/or 11, wherein there is provided at least one fixing device 16, 17 with which the attachment element 9, 10 and/or 11 can be releasably fixed to the base body 7. A plurality of attachment elements 9, 10, 11 can also be fixed to the base body 7 in succession in the longitudinal direction thereof.

In the illustrated case the at least one fixing device 16, 17 includes a permanent magnet 16 arranged on the base body 7 and a magnetisable region 17 on the attachment element 9, 10, 11. The magnetisable region 17 can extend over the entire thickness 69 or a part of the thickness 69 of the attachment elements 9, 10, 11. The permanent magnet can be arranged for example at a front plate 62 of the base body 7 or can be integrated into the front plate 62.

The formwork assembly further includes a centring device 18, 19 with which the attachment elements 9, 10, 11 can be aligned relative to the base body 7, 8 when fixing the attachment elements 9, 10, 11 to the base body 7, 8.

In the illustrated case the centring device 18, 19 includes a centring pin 18 on the attachment element 9, 10, 11 and an opening 19 on the base body 7 for receiving the centring pin 18 (see also FIG. 3). The centring pin 18 has inclined surfaces 68 to facilitate insertion into the opening 19.

The attachment elements 9, 10, 11 shown by way of example have a side 20 facing towards the surface to be concreted and an opposite side 21 facing towards the base body 7.

In the attachment elements 10 and 11 the side 20 towards the surface to be concreted has contour portions 23, 24 deviating from a plane 22 for forming a predetermined contour at a side surface of a precast concrete part to be produced. In the case of the attachment element 10 the contour portion is of a substantially trapezoidal cross-section. In the case of the attachment element 11 two contour portions 24 are arranged on the attachment element 11 at the ends, the contour portions 24 being substantially triangular in cross-section. A corresponding counterpart contour will be produced in the precast concrete part to be produced.

The attachment elements 9, 10, 11 are of a substantially plate-shaped configuration.

The base body 7 further has a pallet fixing device 31 for releasably fixing the base body 7 to the pallet. FIG. 1 more precisely shows an engagement means of the pallet fixing device 31, by way of which a magnet means can be actuated, wherein the magnet means can be brought into contact for fixing the base body 7 with the pallet and can be lifted off the pallet again for releasing the fixing by way of the engagement means 31. The pallet fixing device 31 in the concreting operation prevents slippage of the base body 7 and the attachment element or elements 9, 10, 11 fixed thereto.

And finally in a state in which the base body 7 is fixed to the pallet the base body 7 has an underside 27 facing towards the pallet and, in a state in which the attachment element 9, 10, 11 is releasably fixed to the base body 7, it has a side surface 28 facing towards the attachment element 9, 10, 11.

FIG. 3 shows a second preferred embodiment of an assembled formwork assembly 2 as a diagrammatic cross-sectional view. The pallet 5 is shown in broken lines in this Figure and in FIG. 4.

It will be seen that, in the region in which the underside 27 meets the side surface 28, the base body 7 has a recess 29 so that, in the state in which the base body 7 is fixed to the pallet 5, the base body 7 is at a spacing 30 relative to the pallet 5 in that region. That recess 29 serves to provide that the base body 7 does not come into contact with the pallet 5 in the region of the attachment element 9. This prevents concrete or concrete slurry penetrating from below by means of a capillary action into the intermediate space 26 between the base body 7 and the attachment element 9.

In more specific terms the recess 29 can be achieved by way of a downwardly shortened front plate 62.

In the state of being arranged on the pallet 5 the formwork assembly 2 is therefore supported on the pallet 5 on the one hand by way of the attachment element 9 and on the other hand by way of a support element 61 spaced therefrom.

FIG. 4 shows a third preferred embodiment of an assembled shuttering assembly 3. In this embodiment the attachment element 12—as a further measure for preventing concrete from penetrating into the intermediate space 26 between the base body 8 and the attachment element 12—has a concrete screening device 25 on the side 21 towards the base body 8. In the illustrated case the concrete screening device 25 is in the form of an angled plate.

The base body 8 used in this embodiment, besides the pallet fixing device 31 for releasably fixing the base body 8 to the pallet 5, also has an engagement means 32 for a formwork robot 33 (see also FIG. 8).

FIG. 5 shows a first preferred embodiment of a storage apparatus 34 for a formwork assembly which includes for example base bodies 7 and attachment elements 9, 10.

The storage apparatus 34 includes a transport device 52 for transporting the base bodies 7 and/or the attachment elements 9, 10 from and to at least one formwork robot, wherein in the illustrated case the transport device 52 includes a roller track with rollers 52 which are mounted rotatably about axes of rotation 66 (see also FIG. 6).

Furthermore the storage apparatus 34 includes a plurality of storage facilities 56 for the base bodies 7 and the attachment elements 9, 10, wherein the storage facilities 56 in the illustrated case are in the form of displaceable trays or drawers. Extension guides 64 are provided for guiding the trays or drawers relative to a stationary housing 70.

The trays are of a substantially plate-shaped configuration, wherein at least some of the plates have openings 63 in which the centring pins 18 of the attachment elements 9, 10 can be positioned. That provides that the attachment elements 9, 10 are held on the trays in a stable position.

The storage apparatus 34 further includes a gripping device 39 for transporting the base bodies 7 and the attachment elements 9, 10. The gripping device 39 is in the form of a magnetic gripper, has a head 42 which is pivotable about an axis 41 which is substantially horizontal in the position of use, and is adapted to be displaceable in three mutually perpendicular directions in space 43, 44, 45, as is indicated by double-headed arrows. Linear guides 46, 47, 48 are provided to implement that displaceability.

And finally the storage apparatus 34 includes a plurality of release devices 36 for releasing the fixing between the base bodies 7 and the attachment elements 9, 10.

More specifically operation can be effected with that storage apparatus 34 as follows: an assembled formwork which was previously taken from the pallet by a formwork-removal robot is transported into the proximity of the storage facilities 56 on the rollers 65 of the roller track of the transport device 52. The release devices 36 are disposed at the end of the roller track. The fixing between the attachment element 9, 10 and the base body 7 is released with the release devices. The mode of operation of the release devices 36 is described in detail with reference to FIG. 6. The released attachment element 9, 10 is removed by way of the gripping device 39. The head of the gripping device 39 moves upwardly, that is to say in the direction 45, and a tray 56 opens. The head 42 pivots about the horizontal axis 41 and transfers the attachment element 9, 10 into the opened tray 56. The tray 56 moves in. The base body 7 is now removed and stowed in the same way. To be able to service all positions of the trays 56 the head 42 is mounted longitudinally and transversely, that is to say in the directions in space 43 and 44.

For assembly of a fresh formwork firstly a base body 7 is placed on the roller track and then a desired attachment element 9, 10 is fetched from the tray by means of the gripping device 39 and fitted to the base body 7.

Alternatively the base body 7 can also remain on the roller track and only the attachment element 9, 10 can be replaced when the base body 7 of the old formwork can be used for the new formwork.

As can be seen from the FIG. 6 embodiment the release devices 36 include two spreading elements 37, 38 which are displaceable relative to each other. The release devices 36 are integrated in the roller track. The spreading elements 37, 38 can be moved from below into the base body 7. By virtue of a movement of the spreading elements 37, 38, in which the spacing 71 of the spreading elements 37, 38 is increased, the attachment element 9 is urged away from the base body 7 by way of the centring pins 18 and in that way the fixing between the attachment element 9 and the base body 7 is released. The gripping device 39 can remove the attachment element 9.

In the assembly procedure firstly the base body 7 is put on to the roller track. The spreading elements 37, 38 move out. The attachment element 9 is fetched from the tray array by means of the gripping device 39. The at least one centring device guarantees correct placement and centres the attachment element 9 on the base body 7. The spreading elements 37, 38 now move together, with the spacing 71 between them decreasing. The gripping device 39 simultaneously moves the attachment element 9 in the direction of the base body 7. The interplay in respect of the movement of the spreading elements 37, 38 and the gripping device 39 which holds the attachment element 9 is synchronous. That prevents the attachment element 9 jumping on to the base body 7 under the influence of the magnetic force.

FIG. 7 shows a second preferred embodiment of a storage apparatus 35. The storage apparatus 35 includes a first transport device 54, with which assembled formwork assemblies can be transported from and to a formwork robot. By way of example formwork assemblies 3 are shown in this Figure. The storage apparatus 35 further includes a storage facility 58 for the formwork assemblies. The formwork assemblies can be deposited in and removed from the storage facility 58 with a gripping device 40 which is displaceable in three mutually perpendicular directions in space 43, 44, 45 (linear guides 49, 50, 51 are provided for that purpose).

The formwork assemblies 3 can be transported to an assembly station 67 by way of a second transport device 53. Here an operator can equip different base bodies with attachment elements. Attachment elements 12 are shown by way of example. For storage of the attachment elements 12 the arrangement has a storage facility 57 which is displaceable over rails.

The storage apparatus 35 therefore serves for manual assembly of base bodies and attachment elements, for example base bodies 8 and attachment elements 12. For that purpose the gripping device 40 places a formwork assembly 3 which has already been assembled on the roller track of the transport device 53. The formwork assembly 3 is now transported by means of the driven rollers 65 of the roller track to the position of the assembly station 67. There the attachment element is released from the base body manually by means of one or more release devices 36. The operator 55 places the attachment element in the displaceable magazine 57 for the attachment elements. The operator 55 then takes the fresh attachment element that is required for the next production unit out of the storage means 57 and assembles it to the base body 8 by means of the spreading elements 37, 38 of the release device or devices 36. The operator 55 then feeds the assembled formwork assembly 3 into the automatic region again by way of the roller track.

The process of preparing the formworks is therefore completely separate from the automatic process of laying the formwork. An advantage of this system is that the formwork parts can be prepared in the completely finished state for automatic positioning on the pallet. Specific end termination portions can also be fitted. No subsequent work is therefore required on the formworked pallet.

FIG. 9 shows a fourth preferred embodiment of an assembled formwork assembly 4 on a pallet 5. In the illustrated case the surface 6 to be concreted on the pallet is delimited laterally by a total of six attachment elements 13, 14, 15 releasably fixed to four base bodies 8. In this case there are two transverse dividers which are respectively made up from two attachment elements 13, 14 and a base body 8 and a longitudinal divider which is made up of two mutually juxtaposed units, respectively assembled from an attachment element 15 and a base body 8.

FIG. 10 shows a flow chart for illustrating a preferred embodiment of the method 59 according to the invention. In a first step i at least one base body 7, 8 and at least one attachment element 9, 10, 11, 12, 13, 14, 15 are prepared. In a second step ii the at least one attachment element 9, 10, 11, 12, 13, 14, 15 is automatically aligned relative to the at least one base body 7, 8 by means of the at least one centring device 18, 19. In a third step iii the at least one attachment element 9, 10, 11, 12, 13, 14, 15 is releasably and automatically fixed to the at least one base body 7, 8 by means of the at least one fixing device 16, 17. In a fourth step iv the at least one base body 7, 8 together with the at least one attachment element 9, 10, 11, 12, 13, 14, 15 is automatically arranged on the pallet 5 by means of a formwork robot at a position predetermined by CAD data. In a fifth step v the at least one base body 7, 8 is automatically releasably fixed to the pallet 5 by means of the formwork robot.

Depending on the respective formwork assembly to be produced steps i to v can now be repeated with further base bodies 7, 8 and attachment elements 9, 10, 11, 12, 13, 14, 15 until a predetermined surface 6 to be concreted is completely laterally delimited.

That procedure is indicated by the dotted-line arrow.

The surface 6 is then concreted to produce a predetermined precast concrete part. For dismantling of the formwork in a sixth step vi the fixing of the at least one base body 7, 8 to the pallet 5 is automatically released by means of the formwork robot and in a seventh step vii the at least one base body 7, 8 together with the at least one attachment element 9, 10, 11, 12, 13, 14, 15 is automatically removed from the pallet 5 by means of the formwork robot. Then the at least one base body 7, 8 and the at least one attachment element 9, 10, 11, 12, 13, 14, 15 can be released from each other in an optional eighth step viii, cleaned and/or positioned in at least one storage facility 56, 57, 58.

1. A formwork assembly for laterally delimiting a surface to be concreted on a formwork surface, in particular a pallet or a formwork table, comprising at least one base body which can be releasably fixed to the formwork surface and at least one attachment element, wherein there is provided at least one fixing device with which the at least one attachment element can be fixed releasably and in particular automatically to the at least one base body, characterised in that there is provided at least one centring device which is separate from the at least one fixing device and with which the at least one attachment element upon fixing of the at least one attachment element to the at least one base body can be automatically aligned relative to the at least one base body and the at least one base body and the at least one attachment element can be arranged in the fixed state together on the formwork surface and can be removed from the formwork surface.

2. The formwork assembly according to claim 1, wherein the at least one fixing device and the at least one centring device are structurally different.

3. The formwork assembly according to claim 1, wherein the at least one centring device includes at least one centring pin arranged preferably on the at least one attachment element and at least one opening arranged preferably on the at least one base body for receiving the at least one centring pin.

4. The formwork assembly according to claim 1, wherein the at least one attachment element has a side facing towards the surface to be concreted and an opposite side facing towards the at least one base body, preferably wherein the side facing towards the surface to be concreted has at least one contour portion differing from a plane for producing a predetermined contour at a side surface of a precast concrete part to be produced.

5. The formwork assembly according to claim 4, wherein the at least one attachment element on the side towards the at least one base body has at least one concrete screening device in order in a state in which the at least one attachment element is releasably fixed to the at least one base body to prevent penetration of concrete into an intermediate space between the at least one attachment element and the at least one base body.

6. The formwork assembly according to claim 1, wherein the at least one attachment element is of a substantially plate-shaped configuration.

7. The formwork assembly according to claim 1, wherein the at least one fixing device includes at least one permanent magnet preferably arranged on the at least one base body and at least one magnetisable region arranged on the at least one attachment element.

8. The formwork assembly according to claim 1, wherein the at least one base body in a state in which the at least one base body is fixed to the formwork surface has an underside towards the formwork surface and in a state in which the at least one attachment element is releasably fixed to the at least one base body it has a side surface facing towards the at least one attachment element, wherein in the region in which the underside meets the side surface the base body has at least one recess so that in the state in which the at least one base body is fixed to the formwork surface the at least one base body has in that region a spacing relative to the formwork surface.

9. The formwork assembly according to claim 1, wherein the at least one base body has at least one formwork surface fixing device for releasably fixing the base body to the formwork surface and/or at least one engagement means for a formwork robot.

10. A storage apparatus for the formwork assembly according to claim 1, wherein the storage apparatus has at least one release device for releasing the fixing between the at least one base body and the at least one attachment element, preferably wherein the at least one release device includes two spreading elements displaceable relative to each other.

11. The storage apparatus according to claim 10, wherein the storage apparatus includes at least one gripping device for transporting the at least one base body and/or the at least one attachment element.

12. The storage apparatus according to claim 11, wherein the at least one gripping device is in the form of a magnetic gripper and/or has at least one head pivotable about an axis which in the position of use is substantially horizontal and/or is adapted to be displaceable in three mutually perpendicular directions in space, wherein preferably linear guides are provided to provide the displaceability.

13. The storage apparatus according to claim 10, wherein the storage apparatus includes:
at least one transport device for transporting the at least one base body and/or the at least one attachment element from and to at least one formwork robot and/or an operator, preferably wherein the at least one transport device includes a roller track, and/or
at least one storage facility for the at least one base body and/or the at least one attachment element, preferably wherein the at least one storage facility is adapted to be displaceable, particularly preferably wherein the at least one storage facility is in the form of a displaceable tray.

14. An assembly comprising the formwork assembly according to claim 1 and at least one formwork robot with which the at least one base body together with the at least one attachment element can be automatically arranged on the formwork surface at a predetermined position, preferably predetermined by CAD data and the at least one base body can be automatically releasably fixed to the formwork surface.

15. The assembly according to claim 14, wherein the fixing of the at least one base body at the formwork surface can be automatically released by the at least one formwork robot, and the at least one base body can be automatically removed from the formwork surface together with the at least one attachment element.

16. A method of producing a formwork on a formwork surface, in particular a pallet or a formwork table, using the formwork assembly according to claim 1, the method comprising:
i. providing at least one base body and at least one attachment element,
ii. automatically aligning the at least one attachment element by the at least one centering device relative to the at least one base body,
iii. fixing releasably and automatically the at least one attachment element to the at least one base body by the at least one fixing device,
iv. automatically arranging the at least one base body together with the at least one attachment element by at least one formwork robot on the formwork surface at a predetermined position, preferably predetermined by CAD data, and
v. releasably fixing the at least one base body to the formwork surface, preferably automatically, by at least one formwork robot.

17. The method according to claim 16, wherein steps i. to v. are repeated with further base bodies and attachment elements until a predetermined surface to be concreted is completely laterally delimited, preferably wherein the surface is then concreted.

18. The method according to claim 16, further comprising for dismantling the formwork:
vi. automatically releasing the fixing of the at least one base body to the formwork surface by at least one formwork robot, and
vii. automatically removing the at least one base body together with the at least one attachment element from the formwork surface by at least one formwork robot, and
viii. releasing the at least one base body and the at least one attachment element from each other, and cleaning and/or positioning the at least one base body and the at least one attachment element in at least one storage facility.

19. The assembly according to claim 14, further including at least one storage apparatus having at least one release device for releasing the fixing between the at least one base body and the at least one attachment element, the at least one release device including two spreading elements displaceable relative to each other.
